(19) United States
(12) Patent Application Publication
(10) Pub. No.: US 2008/0133817 A1
(43) Pub. Date: Jun. 5, 2008

(54) Memory module, memory controller, communication unit, and method of operating

(76) Inventors: Ulrich Brandt, Munchen (DE); Gerhard Risse, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/633,871

(22) Filed: Dec. 4, 2006

(51) Int. Cl. G06F 12/00

(52) U.S. Cl. 711/100; 711/E12.001

(57) ABSTRACT

A communication unit is configured to operate with a memory module. The communication unit includes a first connection configured to couple to a memory controller, a second connection configured to couple to memory of the memory module, and a search engine. The search engine includes a search routine activatable by a search request received via the first connection, the search routine when activated searching a memory connected to the second connection for a search pattern received via the first connection.

### BACKGROUND

A memory arrangement generally comprises one or more memory modules and a memory controller. A memory module generally relates to a portion of memory for storing data which may be used alone or in connection with further memory modules to form a memory arrangement. A memory module may be located on a dedicated circuit board or a may be arranged on a circuit board together with other components. A memory controller controls the read operations and, in the case writeable memory, also the write operations of the memory arrangement.

A communication unit is typically associated with a memory module and handling at least part of the communication between a memory controller and the memory module.

### SUMMARY

One embodiment includes a communication unit configured to operate with a memory module. The communication unit includes a first connection configured to couple to a memory controller, a second connection configured to couple to memory of the memory module, and a search engine. The search engine includes a search routine activatable by a search request received via the first connection, the search routine when activated searching a memory connected to the second connection for a search pattern received via the first connection.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of a memory arrangement according to an embodiment.

FIG. 2 illustrates a flow diagram of an embodiment of a method.

FIG. 3 is a graph illustrating a double speed search according to an embodiment.

FIG. 4 is a further graph illustrating the double speed search according to the embodiment of FIG. 3.

FIG. 5 illustrates a flow diagram of a method according to an embodiment handling a write request during a search being performed.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments relate to a communication unit for a memory module, a corresponding memory module, a memory arrangement, a memory controller and methods of operation thereof.

In the following, embodiments are described in detail. In order to make the following description more precise, some terms used within the description will be defined first:

The term “memory” generally relates to all types of memory devices used for storing data, in particular both to rewritable types of memory like random access memory (RAM), flash memory and the like and to memory which may be read out only like read only memory (ROM), or only written to once like electrically programmable read only memory (EPROM) and subtypes thereof. Examples for subtypes are Static RAM (SRAM) and Dynamic RAM (DRAM) as subtypes of RAM.

The term “memory module” generally relates to a portion of memory for storing data which may be used alone or in connection with further memory modules to form a memory arrangement. A memory module in this sense may be located on a dedicated circuit board (e.g., dual inline memory modules (DIMMs) used for example as memory in computers) or may be arranged on a circuit board together with other components.

A memory arrangement generally comprises one or more memory modules and a memory controller. A memory controller in this context refers to an entity controlling the read operations and, in case of writable memory, also the write operations of the memory arrangement.

A communication unit refers generally to a unit associated with a memory module and handling at least part of the communication between a memory controller and the memory module. An example for communication units are referred to as advanced memory buffers (AMB) used in fully-buffered DIMM.

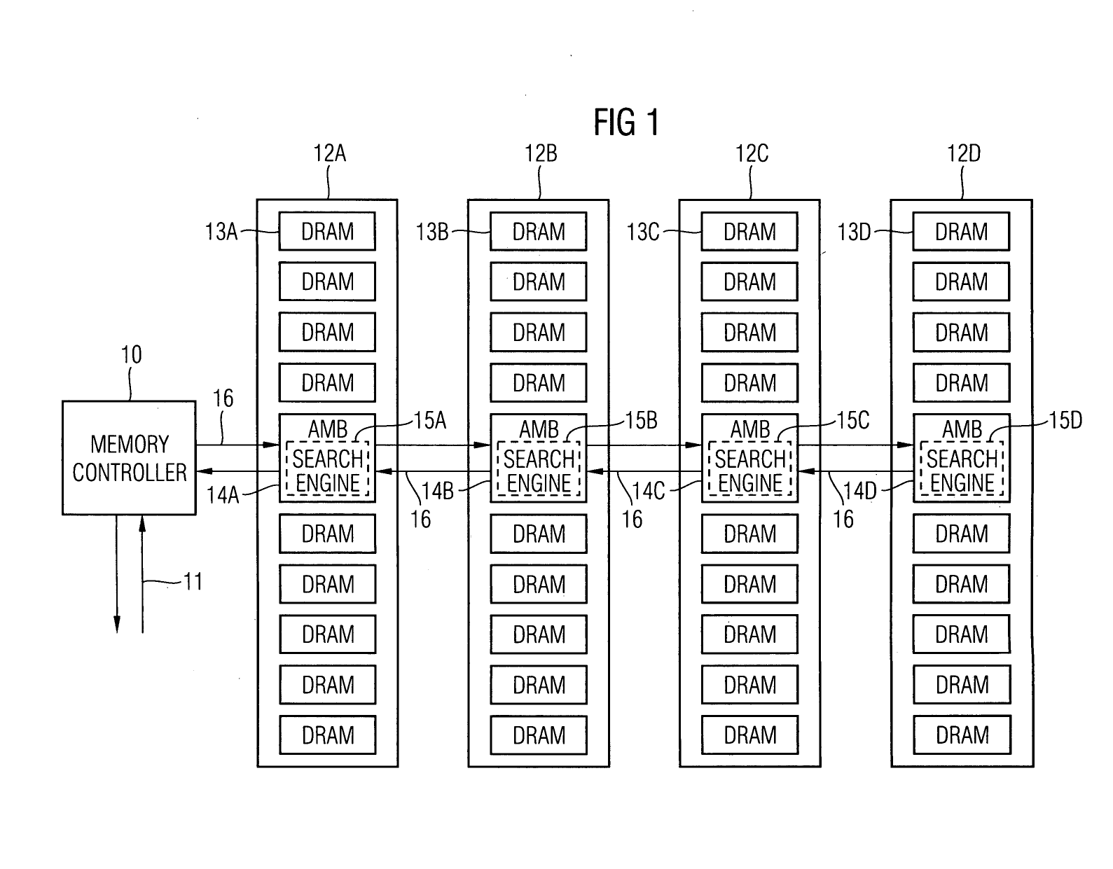

FIG. 1 illustrates an embodiment of a memory arrangement realized as a fully-buffered DIMM (FB-DIMM). The memory arrangement illustrated in FIG. 1 comprises a memory controller 10 and four memory modules 12A, 12B, 12C and 12D, collectively referred to in the following as memory modules 12. Each of the memory modules of this embodiment comprises nine (DRAM) chips 13A, 13B, 13C and 13D, respectively, collectively referred to in the following as DRAMs 13. Furthermore, each memory module comprises an advanced memory buffer designated 14A, 14B, 14C and 14D, respectively, collectively referred to (AMB) in the following AMBs 14. AMBs 14 are examples for communication units as defined above.

In the embodiment illustrated, memory modules 12A, 12B, 12C and 12D are arranged on respective separate circuit boards which for example may be inserted into corresponding slots on a motherboard of a computer (e.g., a server or a workstation).

The read and write operations of the memory arrangement illustrated in FIG. 1 is described in the following:

Memory controller 10 receives, as indicated by arrows 11, a read request or a write request from the system in which the memory arrangement illustrated is installed, for example from a central processing unit of a computer.

Memory controller 10 then, as indicated by arrows 16, forwards the request to the AMB(s) 14 of the corresponding memory module(s) where the memory address to be read out or to be written to is located, for example to AMB 14A in case the memory corresponding to the memory address is located on memory module 12A. As illustrated in FIG. 1, if such a request is to be forwarded to AMB 14C, this forwarding takes place via AMBs 14A and 14B. In other words, the AMBs 14 and memory controller 10 are connected serially in the chain.

The corresponding AMB, for example AMB 14A, then forwards the read/write request to the corresponding DRAM(s) of the corresponding memory module, wherein AMB 15A buffers the data to be written to the memory or the data read out from the memory. The AMB 15A then sends the read out data back to memory controller 10. In case of a read operation, memory controller 10 then forwards the read out data to the requesting entity like the above-mentioned central processing unit.

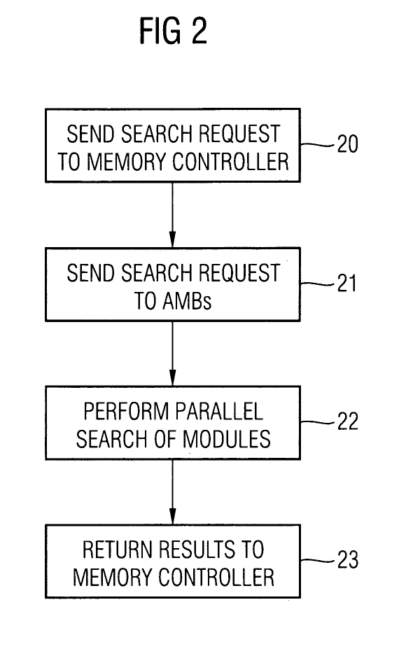

In the embodiment illustrated in FIG. 1, each of the AMBs 14 comprises a search engine, labeled 15A, 15B, 15C and 15D, respectively, and collectively being referred to as search engines 15 in the following. Search engines 15 serve for searching the memory of the corresponding memory module 12 for a specific pattern stored in the memory, for example a specified series of “1” and “0”. An embodiment of a method for performing such a search is illustrated in form of a flow diagram in FIG. 2.

At 20, a search request for searching a specific pattern in the memory constituted by DRAMs 13 of memory modules 12 is sent to memory controller 10, for example by a central processing unit. Memory controller 10 then, at 21, sends the search request to all AMBs 14 and in particular the search engines 15 thereof. Search engines 15 then in parallel each search their corresponding memory module for the pattern to be searched by comparing the data stored in the DRAMs 13 which said pattern. Finally, at 23, the search results are returned to memory controller 10, for example in form of memory addresses where the searched pattern is stored or a signal indicating that the searched pattern was not found.

In the embodiment illustrated, since all search engines 15 perform the search in parallel, a quick search is possible.

In one specific embodiment, search engines 15 are incorporated in a self-test function of AMBs 14. Such self-test functions are provided in conventional AMBs for self-testing of the memory modules and are commonly referred to as memory built-in self-test (MemBIST).

In particular, in this case functions of the built-in self-test for comparing of data and the like may be used within search engines 15.

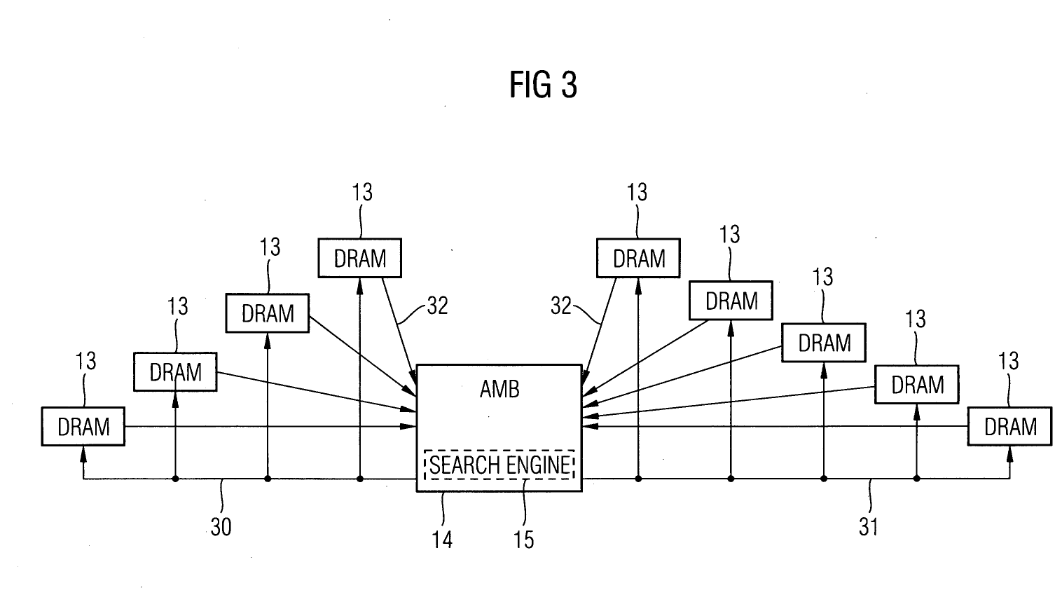

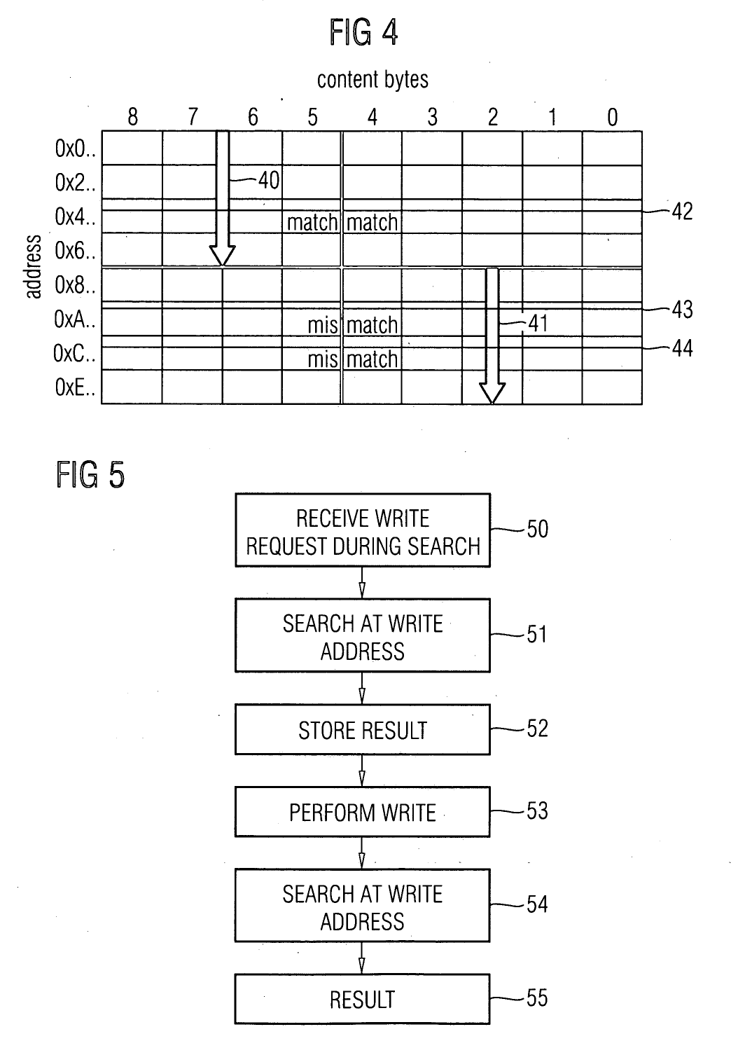

In the memory arrangement of FIG. 1, nine DRAM chips 13 are present on each memory module 12. For addressing these DRAM chips by the respective AMB 14, a single address bus may be provided. Alternatively, it is possible to provide two or more address busses, wherein each address bus addresses a group of DRAMs 13. In case two or more address busses are provided, according to an embodiment, this is used for further accelerating the search performed by the corresponding search engine. Such an embodiment where two address busses are used in a memory module will be explained in the following with reference to FIGS. 3 and 4.

In the embodiment of FIGS. 3 and 4, data is stored in groups of 72 bits corresponding to 9 bytes, wherein one of the bytes is stored in each of the nine DRAMs of the corresponding memory module. In other words, one memory address corresponds to 72 bits, and for a write to this memory address, one byte is written to each DRAM 13, whereas for a read operation one byte is read from each DRAM 13. This corresponds to the situation in conventional fully-buffered DIMMs. However, in other embodiments other systems for distributing the data to the memory of the memory module may be employed.

In the embodiment illustrated in FIG. 3 two address busses 30, 31 are provided, address bus 30 addressing four DRAMs and address bus 31 addressing five DRAMs. In the normal read/write operation as mentioned above, the addresses selected by address bus 30 and address bus 31 correspond to the same memory address. In a read operation as indicated by arrows 32 in FIG. 3 the corresponding value is sent to AMB 14 from DRAMs 13. Conversely, during a write operation, the corresponding values are written to the DRAMs 13.

In the embodiment illustrated, if a search as mentioned is to be performed by search engine 15, the address space (i.e., the set of memory addresses on the respective memory module) is split in two, one part of the address space being searched via address bus 30 and the other part being searched by address bus 31. In embodiments where more than two address busses are provided, the address space correspondingly may be split in more than two parts.

This concept will be further explained with reference to FIG. 4. Here, the address space of the memory module is depicted on the vertical axis, whereas the horizontal axis denoted the “content bytes” (i.e., the bytes forming the 72 bit patterns which are stored in separate DRAMs as explained above). In particular, in the embodiment illustrated, content bytes 8-5 are stored in the DRAMs addressed by address bus 30, whereas content bytes 4-0 are stored in the DRAMs addressed by address bus 31.

Since in the embodiment illustrated two address busses are present, the address space for performing the search is split in two, wherein addresses up to 0-0x7ff . . . f are searched via address bus 30 as indicated by arrow 40, whereas address from 0x8 . . . on are searched via address bus 31 as indicated by arrow 41.

For searching, the content bytes addressed by the corresponding address bus are retrieved (i.e., sent to AMB 14) and compared with the search pattern or part thereof in search engine 15.

Therefore, during the search, it is checked whether the content bytes addressable by the corresponding address bus 30 or 31 match the pattern, for example a 72 bit pattern to be searched in the present case. Only if a match is found here, the remaining content bytes are also checked in order to determine if in fact a full match has been found.

In the example illustrated in FIG. 4, during the search performed using address bus 30 and content bytes 8-5 a match is found at the address indicated by horizontal line 42, meaning that the first 4×8=32 bits match with the 72 bit search pattern. In this case, address bus 31 is used to retrieve also content bytes 0-4 of this memory address, and search engine 15 compares these bytes with the lower bits of the search pattern in order to determine whether a full match has been found. In case of the address 42, as an example this is the case and indicated by the word “match” on both sides of the line separating the content bytes searched using address bus 30 from the content bytes searched using address bus 31.

In the part of the address space searched using address bus 31 as indicated by arrow 41, the retrieved content bytes are compared with the lower 5×8=40 bits of the search pattern. Only if a match is found, which in the example illustrated is the case for the addresses indicated by horizontal lines 43 and 44, address bus 30 is used to retrieve content bytes 5-8 for these addresses to check whether also these bytes match. In the example illustrated, this is not the case as indicated by the word “mismatch”.

The search in the two parts of the address space as indicated by arrows 40 and 41 can be performed in parallel. In this way, the search speed is almost doubled compared with the case where the whole address space is searched consecutively, since only for those addresses where a partial match is found using one address bus the whole data stored at that address has to be retrieved.

As a matter of course, the partitioning of the address space illustrated in FIG. 4 is to be taken as an example only, and other partitionings are also possible.

In the embodiment illustrated, the AMBs 14 receive a search request from memory controller 10 and send the results to memory controller 10 after the results for the corresponding memory module or, in a different embodiment, the results of all the memory modules are present. In these embodiments, no communication regarding the search is performed between memory controller 10 and AMBs 14 inbetween.

While the search is performed, read or write requests may be sent to memory controller 10 by other entities like a CPU.

According to an embodiment, while the search is performed, these read and write requests are refused or delayed until the search is completed. In other words, in this embodiment after memory controller 10 has sent a search request to AMBs 14, when memory controller 10 receives a read request or a write request it refuses this request or it stores the parameters of the request in a buffer memory (not illustrated) for delaying the request until the search results have been returned to memory controller 10.

In this case where no read and write operations are allowed during search, the corresponding connections indicated by arrows 16 are powered down in a particular embodiment (i.e., their power consumption can be reduced) while the search is being performed.

In other embodiments of the invention, read and write operations are allowed also while a search is being performed. In this case, read and write requests received by memory controller 10 are forwarded as already described above to the corresponding AMB(s) 14.

In case read and write access is possible during the search, according to an embodiment, the search is interrupted when an AMB receives a read or write request. In case of a write request, the situation may occur where the write operation changes the result of the search. In embodiments, this is being monitored, and corresponding information is returned to memory controller 10. A method according to such an embodiment is discussed with reference to FIG. 5. The method for FIG. 5, in an embodiment, is implemented in an AMB 14 of a memory module 12 of FIG. 1.

The method of FIG. 5 is executed when, at 50, AMB 14 receives a write request while performing a search via its search engine 15. In this case, the search is interrupted, and at 51 a search at the address to which data is to be written is performed (i.e., the data stored at said write address is compared with the search pattern). At 52, the result, either a match or a mismatch, is stored.

After that, at 53 the write operation is performed (i.e., data is written to the write address overwriting the previously stored data).

At 54, again a search at the write address like the one performed at 51 is performed (i.e., it is again checked whether the data stored at the write address matches the search pattern). Since the old data stored there has been overwritten by new data at 53, the results obtained at 54 may differ from the results obtained at 51.

Finally, at 55 the results are output. Various types of results are possible which may for example be identified by returning different codes or flags to memory controller 10. In one embodiment, the following results are possible:

no match (i.e., neither the old data nor the new data at the write address matches the search pattern);

no match with the old data, but match with the new data (in which case for example a flag NEW may be returned);

match with the old data which is overwritten, but no match with the new data (flag OLD); and

match with both new data and old data (possible flag: CONTINUOUS).

Additionally, it is possible to return a flag CONSTANT if the new data is the same as the old data irrespective of the matching conditions.

The method illustrated in FIG. 5 is only one possibility for obtaining this information. For example, instead of first writing the data to the memory at 53 and then performing the search at the write address, in another embodiment the data to be written is compared with the search pattern before writing.

It has been explained above that the search pattern may for example be a series of 1 and 0 to be compared with bit patterns stored in the memory, for example a search pattern of 1100 in case data is stored in groups 4 bits or a 72-bit pattern in case of the storage of 72 bit groups as explained. Any other length of the search pattern is also possible. In other embodiments the search pattern may also comprise so-called “don't cares” which designate bits where a match can be obtained both if the bit has a value of 1 and if the bit has a value of 0. Taking X as a representation of such a don't care value, a search pattern of 11X0 would yield a match both for a stored value of 1110 and 1100.

Furthermore, in the embodiments discussed above the memory comprises bits which may assume either a state of 1 or a state of 0. It is also possible, in different embodiments, to arrange the memory in a way to be able to have more than two states, for examples three states, a 1, a 0 and a “don't care” state similar to the don't care search pattern above to which both a 1 in a search pattern or a 0 in a search pattern matches. Such a memory may for example be realized by combining two bits or a conventional memory to a “three state bit” wherein a combination 00 corresponds to a value of 0 of the three state bit, a combination 11 of the two bits corresponds to a 1 of the three state bit and a 10 or a 01 corresponds to a don't care.

Embodiments, as mentioned above, may be used in computers, but also in other electronic devices like routers, personal digital assistance, mobile phones or the like. For example, in PDA or mobile phone applications, the search functionality provided by the search engines 15 may be used for finding an entry in an address data base, in a router it may be used for locating an entry in a routing table to determine the connection to take for a specific IP address, the IP address in this case being used for forming the search pattern. Other applications comprise data base applications wherein a specific entry in the data base is searched using the searching functionality of the search engines.

As a matter of course, the above-described embodiments are to be taken as examples only, and numerous modifications are possible without departing from the scope of the present invention. Some of the possible modifications will be discussed below.

In the embodiment illustrated, four memory modules 12A-12D were provided. However, the number of memory modules may vary according to the application. For example, in some computers, a plurality of slots for memory modules are provided, and an arbitrary number of modules starting from a single module may be inserted in order to provide as much memory as desired by the user.

Furthermore, in the embodiment illustrated search engines 15 were implemented in AMB. In other embodiments, search engines 15 are provided as separate entities, for example separate chips, on the memory modules and are controlled by memory controller 10 for performing the search. This in particular may be implemented in embodiments which are not based on fully-buffered DIMMs (i.e., memory modules which do not have an AMB) for example conventional DIMMs. In other embodiments, the search engine may be incorporated in a memory chip of the memory module.

Also, as already mentioned above, while the memory modules in the embodiments illustrated each have dedicated circuit boards, in other embodiments the memory modules may be put on a common circuit board, either alone or together with further components like the memory controller, a processing unit and the like.

In yet further embodiments, the search request sent by the memory controller comprises, beside the search pattern, a memory range to be searched, for example by indicating a start address and an end address. In this case, the search engines only search the part of the memory indicated by the memory range.

Furthermore, in the embodiment illustrated in FIG. 1, each memory module has nine DRAM chips forming the memory of the memory module. The number and type of chips may also be varied in other embodiments of the invention, any number of memory chips may be provided starting from one memory chip. Further, as already mentioned in the definition of various times used, the type of memory is not limited to DRAM, but any type of memory, both writable and not writable, may be used within the context of the present invention, for example read only memory (ROM), static RAM, flash memory, EPROM, and the like.

Although specific embodiments have been illustrated and described herein, it will be appreciated by those of ordinary skill in the art that a variety of alternate and/or equivalent implementations may be substituted for the specific embodiments illustrated and described without departing from the scope of the present invention. This application is intended to cover any adaptations or variations of the specific embodiments discussed herein. Therefore, it is intended that this invention be limited only by the claims and the equivalents thereof.

What is claimed is:

1. A communication unit configured to operate with a memory module, the communication unit comprising:
a first connection configured to couple to a memory controller;
a second connection configured to couple to memory of the memory module; and
a search engine comprising:
a search routine activatable by a search request received via the first connection, the search routine when activated searching a memory connected to the second connection for a search pattern received via the first connection.

2. The communication unit according to claim 1, wherein the search engine is implemented in a self-test engine.

3. The communication unit according to claim 1, wherein the communication unit comprises an advanced memory buffer.

4. The communication unit according to claim 1, wherein the second connection comprises a first address bus and a second address bus, the search routine when activated searches a first part of the memory using the first address bus and a second part of the memory using the second address bus.

5. The communication unit according to claim 4, wherein the search routine when activated performs the following:
searches data in the first part of the memory by comparing a first part of data stored in the memory with a first part of the search pattern;
searches the second part of the memory by comparing a second part of data stored therein with a second part of a search pattern; and
compares the respective other part of the data with the respective other part of the search pattern only if the first comparison results in a match.

6. A communication unit for a memory module, the communication unit comprising:
means for searching a memory associated with the communication unit in response to a search request received from a memory controller.

7. The communication unit according to claim 6, comprising:
means for receiving at least one of read or write requests from the memory controller and forwarding the requests to memory associated with the communication unit.

8. The communication unit according to claim 6, comprising:
means for communicating with the memory controller; and
means for communicating with the memory.

9. A memory module, comprising:
a memory; and
a communication unit comprising:
a first connection configured to couple to a memory controller;
a second connection configured to couple to memory of the memory module; and
a search engine comprising:
a search routine activatable by a search request received via the first connection, the search routine when activated searching a memory connected to the second connection for a search pattern received via the first connection.

10. The memory module according to claim 9, the memory comprising:
at least one of a random access memory, a read only memory, a flash memory, and a electrically programmable read only memory.

11. The memory module according to claim 9, wherein the memory module comprises a dedicated circuit board.

12. The memory module according to claim 9, wherein the memory module is implemented as a dual inline memory module.

13. The memory module according to claim 9, wherein the communication unit is implemented as an advanced memory buffer.

14. The memory module according to claim 9, wherein the memory comprises a plurality of memory chips, each memory chip configured to store to part of data stored at a given memory address of the memory.

15. The memory module according to claim 14, wherein the second connector comprises:
a first address bus and a second address bus;
wherein the search routine when activated searches a first part of the memory using the first address bus and a second part of the memory using the second address bus;
wherein the first part of the memory comprises a first part of the memory chips and the second part of the memory comprises a second part of the memory chips.

16. A memory controller configured to operate in a memory arrangement, the memory controller comprising:
a search mechanism, the search mechanism when activated by an external search request is configured to send control signals to a plurality of memory modules for parallel search of the plurality of memory modules.

17. The memory controller according to claim 16, wherein the search mechanism when activated is configured to block at least one of read requests and write requests received while a search is being performed.

18. A memory arrangement, comprising:
a memory controller comprising a search mechanism; and
at least one memory module comprising:
a memory; and
a communication unit comprising:
a first connection configured to couple to a memory controller;
a second connection configured to couple to memory of the memory module; and
a search engine comprising:
a search routine activatable by a search request received via the first connection, the search routine when activated searching a memory connected to the second connection for a search pattern received via the first connection.

19. The memory arrangement according to claim 18,
wherein the at least one memory module comprising at least two memory modules;
wherein the search routines of the communication units of the at least two memory modules are activated in parallel by the search mechanism of the memory controller.

20. An electronic device, comprising:
a memory controller for a memory arrangement comprising:
the memory controller comprising a search mechanism, the search mechanism when activated by a search request is configured to send control signals to at least one memory module for parallel search of the at least one memory module.

21. The electronic device according to claim 20, further comprising:
at least one memory module comprising:
a memory; and
a communication unit comprising:
a search engine;
a first connection coupled to the memory controller;
a second connection coupled to the memory of the memory module; and
the search engine comprising:
a search routine activatable by a search request received from the memory controller, the search routine when activated configured to search the memory for a search pattern received from the memory controller.

22. The electronic device according to claim 21, wherein the electronic device is one of a computer, a personal digital assistant, a mobile phone, and a router.

23. A method for searching a memory, comprising:
receiving a search pattern; and
searching at least two memory modules of the memory in parallel for matches with the search pattern.

24. The method according to claim 23, wherein the parallel searching is performed by a plurality of search engines, each search engine associated with one of the at least two memory modules.

25. The method according to claim 23, comprising:
receiving a write request for writing new data to the memory at a memory address;
comparing old data stored at that memory address with the search pattern;
comparing the new data to be stored at the memory address with the search pattern; and
outputting information indicative of whether no match occurred, a match only with the old data occurred, a match only with the new data occurred, or both.

26. The method according to claim 21, comprising:
reducing a power consumption of a connection between a memory controller and the at least two memory modules while the search is being performed.

27. A method for searching a memory module, comprising:
receiving a search request comprising a search pattern from a memory controller; and
searching a memory of the memory module for matches with the search pattern using a search engine associated with the memory module.

28. The method according to claim 27, wherein the memory module is a fully-buffered dual inline memory module.
